(19) United States
(12) Patent Application Publication
(10) Pub. No.: US 2015/0278722 A1
(43) Pub. Date: Oct. 1, 2015

(54) EVENT PROCESSING DEVICE, EVENT PROCESSING METHOD, AND EVENT PROCESSING PROGRAM

(71) Applicant: NEC CORPORATION, Tokyo (JP)

(72) Inventor: Itaru Hosomi, Tokyo (JP)

(73) Assignee: NEC Corporation, Tokyo (JP)

(21) Appl. No.: 14/434,972

(22) PCT Filed: Sep. 4, 2013
(86) PCT No.: PCT/JP2013/005223

§ 371 Date: Apr. 10, 2015

(30) Foreign Application Priority Data
Oct. 17, 2012 (JP) 2012-229796

(51) Int. Cl. G06Q 10/06; G06Q 50/00

(52) U.S. Cl. CPC G06Q 10/063; G06Q 50/01

(57) ABSTRACT

Provided is an event processing device capable of eliminating an inconsistency between events in sequential processing in complex event processing of taking input events acquired from many origination sources. The event processing device 50 includes the event data storage means 51 for storing a set of event data mutually associated under a predetermined condition until a predetermined holding deadline, the event evaluation means 52 for, when newly-input event data meets the predetermined condition, including the event data as new event data in the set, and the event competition elimination means 53 for, when new event data is competitive data in which a competition is caused in attribute values for a common attribute with other event data included in the set, excluding the competitive data from the set.

### TECHNICAL FIELD

The present invention relates to an event processing device, an event processing method, and an event processing program.

### BACKGROUND ART

A method for effectively using big data for business is paid attention around the world. The big data means various types of data. A large amount of constantly-generated data, such as sensors' data such as temperature, a result of recognitions of monitoring cameras' video, or text data of social media including Twitter (registered trademark), are paid attention among various types. Therefore, there is increasingly expected a complex event processing (denoted as CEP below) technique for analyzing a large amount of constantly-generated data in real-time.

The CEP is not a technique for independently processing individual items of data originated from a single information source but a technique for detecting occurrences of desired events in real-time by associating and evaluating a plurality of items of continuous data or non-continuous data acquired from different information sources in sequential processing.

For example, a system for providing a security service is realized by the CEP. The system is such that a warning of an unauthorized person is issued when the total number of issued numbered tickets for a service in a facility exceeds the number of visitors when the entry card sensor at the visitor entry gate in the facility counts the entries of a certain number of visitors.

The CEP-mounted systems include products such as Oracle (registered trademark) CEP (see NPL 1) and InfoSphere (registered trademark) Streams by IBM (see NPL 2), and open source software such as Esper (see NPL 3).

The present CEP is described in order to associate and evaluate a plurality of associable events in a rule that the origination sources (including the same origination sources as the association sources) of target events are previously defined. Events to be referred to in any of the prepared rules, among the input events, are held in a memory until all the events are evaluated in the referred rule.

However, when an information origination source is a message originator of social media, the information originators for a common or associated event cannot be specified, and thus the origination sources (originators) of an event to be previously associated is difficult to designate. There is a possibility that if items of information from many origination sources (such as message originators) are associated, the contents of the originated information may be inconsistent with each other.

For example, when an originator originates an item of information “have a meeting with person A at place P at time/date T1” and another originator originates an items of information “have a meeting with person A at place P at time/date T2”, if a rule for associating the events common in event type (meeting), target (person A) and place (P) is present, the two events are handled as associated events.

When the time/date T1 is largely different from the time/date T2, the meetings are likely to be different meetings. Thus, in this case, the processing of handling both of the meetings as an associated event seems to be improper in many cases. The CEP cannot detect or eliminate the inconsistency between the time/date T1 and the time/date T2 in this example.

PLT 1 discloses therein a method for extracting a large number of items of business information from texts such as news and blogs and automatically detecting business-associated events such as increased competitions or enhanced cooperation between companies. With the method, many items of business information on a combination of two companies for the same business are counted per relational type such as competition, cooperation or acquisition, and a relationship between or the strengths of the companies are determined at a certain point of time depending on the magnitude of a score of each relational type.

With the method described in PLT 1, when there is caused an inconsistency that a plurality of relational types occur in a combination of companies for the same business and an orientation indicating which company acquires the other is different per relational type in a plurality of items of business information, the inconsistency is reflected on a score indicating the strength of the relationship. For example, when an inconsistency is present between a plurality of items of business information, the score is low. By use of such a method, the method described in PLT 1 adjusts reliability of a business event to be detected.

### CITATION LIST

### Patent Literature

PLT 1: JP 4795417 B2 Non Patent Literature

NPL 1: “Oracle Complex Event Processing”, [online] Oracle Corporation Japan, [searched on Sep. 26, 2012], Internet <URL: http://www.oracle.com/technetwork/jp/middleware/complex-event-processing/index.html>

NPL 2: “InfoSphere Streams”, [online], IBM Japan, Ltd. [searched on Sep. 26, 2012], Internet <URL: http://www-06.ibm.com/software/jp/data/infosphere/streams/>

NPL 3: “Esper—Complex Event Processing”, [online], EsperTech, [searched on Sep. 26, 2012], Internet <URL: http://esper.codehaus.org/>

### SUMMARY OF INVENTION

### Technical Problem

A complex event processing device (which will be denoted as CEP device below) illustrated in FIG. 10 does not include a means for detecting and eliminating an inconsistency between events' attributes when evaluating the events in combination. The inconsistency elimination method described in PLT 1 is not assumed to be applied to sequential processing such as CEP.

The inconsistency elimination method described in PLT 1 assumes that all events to be evaluated are previously recorded in a database. The inconsistency elimination method calculates a collation score indicating reliability of the presence of a business relationship for all the events, thereby mining the business relationships.

Therefore, the method described in PLT 1 is difficult to apply to the CEP system into which new events are sequentially input. Thus, a method for eliminating inconsistencies between events in sequential processing is required as in the processing in other CEP-mounted systems.

It is therefore an object of the present invention to provide an event processing device capable of eliminating an inconsistency between events in sequential processing in complex event processing of taking input events acquired from many origination sources, an event processing method, and an event processing program.

### Solution to Problem

An event processing device according to the present invention includes an event data storage means for storing a set of event data mutually associated under a predetermined condition until a predetermined holding deadline, an event evaluation means for, when newly-input event data meets the predetermined condition, including the event data as new event data in the set, and an event competition elimination means for, when the new event data is competitive data in which a competition is caused in attribute values of a common attribute with other event data included in the set, excluding the competitive data from the set.

An event processing method according to the present invention includes the steps of storing a set of event data mutually associated under a predetermined condition until a predetermined holding deadline, when newly-input event data meets the predetermined condition, including the event data as new event data in the set, and when the new event data is competitive data in which a competition is caused in attribute values of a common attribute with other event data included in the set, excluding the competitive data from the set.

An event processing program according to the present invention includes causing a computer to perform event data storage processing of storing a set of event data mutually associated under a predetermined condition until a predetermined holding deadline, event evaluation processing of, when newly-input event data meets the predetermined condition, including the event data as new event data in the set, and event competition elimination processing of, when the new event data is competitive data in which a competition is caused in attribute values of a common attribute with other event data included in the set, excluding the competitive data from the set.

### Advantageous Effects of Invention

According to the present invention, it is possible to eliminate an inconsistency between events in sequential processing in complex event processing for taking input events acquired from many origination sources.

### BRIEF DESCRIPTION OF DRAWINGS

FIG. 1 It depicts a block diagram illustrating an exemplary structure of an event processing device according to a first exemplary embodiment.

FIG. 2 It depicts a flowchart illustrating the operations of the event processing device.

FIG. 3 It depicts an explanatory diagram illustrating exemplary events input into the event processing device.

FIG. 4 It depicts a state transition diagram illustrating exemplary rules used in the event processing device.

FIG. 5 It depicts an explanatory diagram illustrating an exemplary concept dictionary used in the event processing device.

FIG. 6 It depicts an explanatory diagram illustrating an exemplary complex event output from the event processing device.

FIG. 7 It depicts an explanatory diagram illustrating an exemplary hardware structure of the event processing device.

FIG. 8 It depicts a block diagram illustrating an exemplary structure of an event processing device according to a second exemplary embodiment.

FIG. 9 It depicts a block diagram illustrating an outline of the event processing device.

FIG. 10 It depicts a block diagram illustrating an exemplary structure common in typical complex event processing devices.

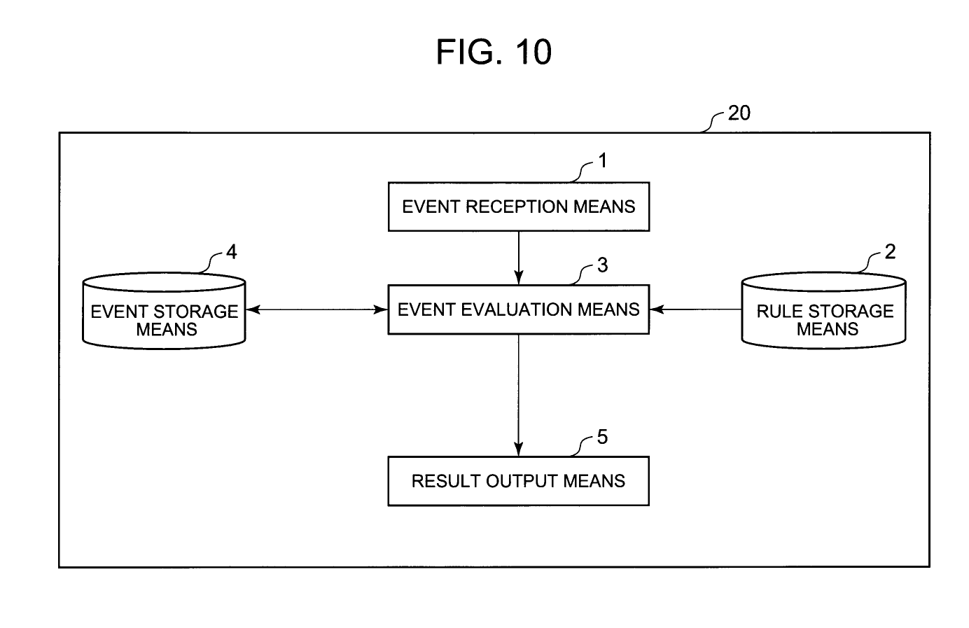

### DESCRIPTION OF EMBODIMENTS

### First Exemplary Embodiment

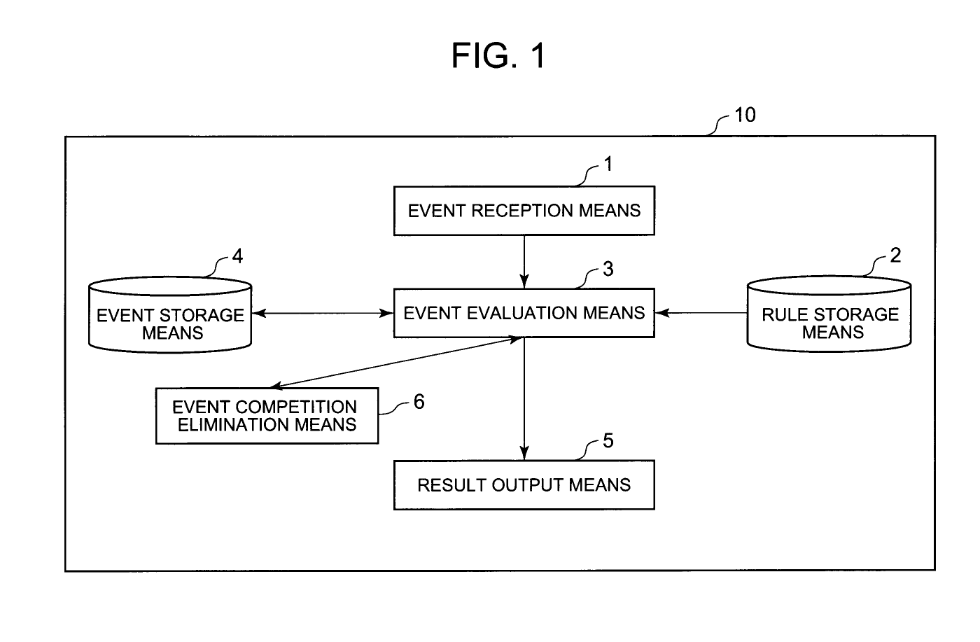

A first exemplary embodiment according to the present invention will be described below with reference to the drawings. FIG. 1 is a block diagram illustrating an exemplary structure of an event processing device according to the first exemplary embodiment of the present invention. The event processing device 10 illustrated in FIG. 1 includes an event reception means 1, a rule storage means 2, an event evaluation means 3, an event storage means 4, a result output means 5, and an event competition elimination means 6.

The event reception means 1 has a function of receiving an event originated from an external origination source.

The rule storage means 2 has a function of storing the entire rule for evaluating the events received by the event reception means 1. The entire rule for evaluating events includes a rule for grouping events and a condition for outputting a group.

The rule storage means 2 may store a concept dictionary described later therein.

The event evaluation means 3 has a function of determining (denoted as collating below) whether one or more events received by the event reception means 1 comply with a rule stored in the rule storage means 2. Further, the event evaluation means 3 has a function of, when one or more received events comply with (denoted as adapt to below) a rule, including the events in a set of specific events.

The event storage means 4 has a function of, when the event reception means 1 receives an event adapted to a rule stored in the rule storage means 2, storing the event until a predetermined deadline. The event storage means 4 may store events not adapted to a rule.

The result output means 5 has a function of, when the event evaluation means 3 determines that all the conditions to the end state described in the entire rule stored in the rule storage means 2 are met, outputting a specific complex event. The complex event is an analysis result of a set of events, which is analyzed based on an analysis rule by the event processing device 10.

The event competition elimination means 6 has a function of detecting whether an attribute with different (denoted as competitive below) attribute values is included in collated events as a result of the collation of the combined events by the event evaluation means 3. The attribute value indicates each attribute of an event.

The event competition elimination means 6 has a function of, when detecting that an attribute which can cause a competition between collated events is included, excluding one or more received events from the set of specific events.

The event competition elimination means 6 may have a function of, when the same attribute has different attribute values between a plurality of events received from the same origination source, employing the later-received newer attribute value.

The event competition elimination means 6 may have a function of, when the same attribute has different attribute values between a plurality of events received from different origination sources, employing the attribute value included in the event earlier stored in the event storage means 4.

The event competition elimination means 6 has these functions, and can eliminate inconsistent or conflicting information due to different attribute values of the same attribute.

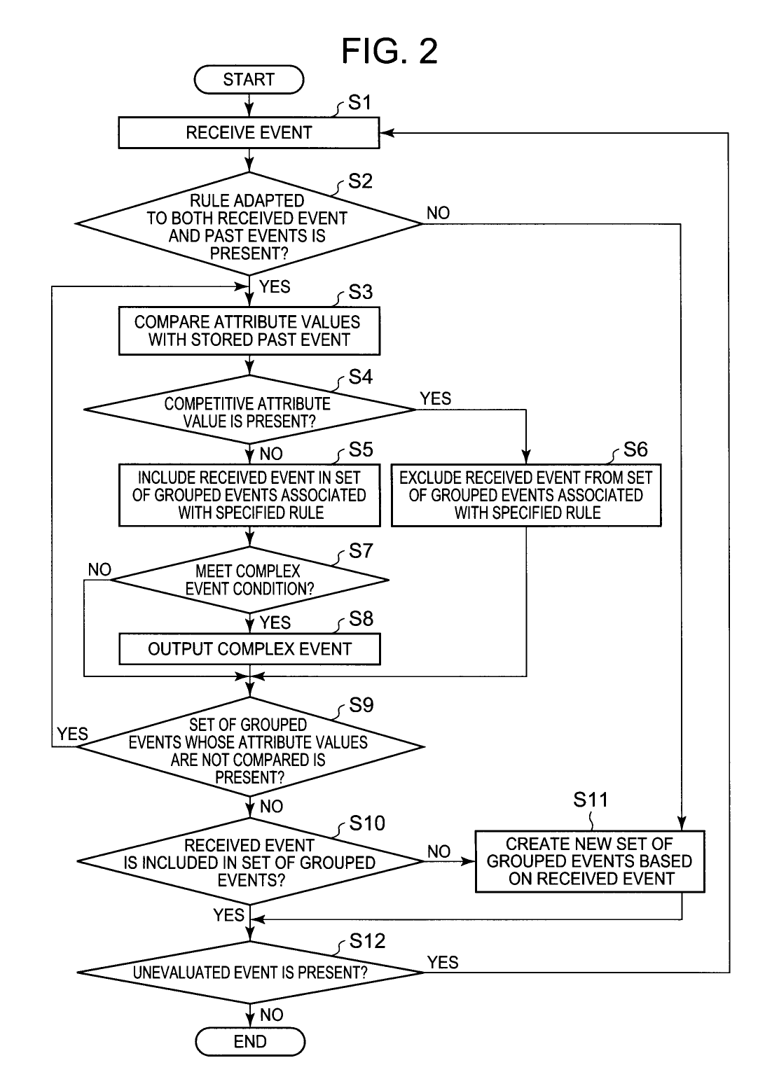

The operations according to the present invention will be described below with reference to FIG. 2. FIG. 2 is a flowchart illustrating the operations of the event processing device according to the present invention.

The event reception means 1 in the event processing device 10 receives a new event (step S1). The event reception means 1 inputs the received new event into the event evaluation means 3.

The event evaluation means 3 confirms whether the entire rule including a rule adapted to the newly-received event and adapted also to the past events is present in the rule storage means 2 (step S2).

When the entire rule including a rule adapted to the received event and adapted also to the past events is not present in the rule storage means 2 (No in step S2), the event evaluation means 3 creates a new set of events based on the received event (step S11).

When the entire rule including a rule adapted to the received event and adapted also to the past events is present in the rule storage means 2 (Yes in step S2), the event evaluation means 3 specifies an event associated with the entire rule specified in step S2 from among the past events stored in the event storage means 4. At this time, the event evaluation means 3 may specify a plurality of past events.

After the event evaluation means 3 specifies a past event, the event competition elimination means 6 compares the attribute values of each common attribute between the specified past event and the newly-input event (step S3). At this time, the event competition elimination means 6 excludes a specific attribute not related to the contents of the events, such as attribute for specifying an originator, from the attributes to be compared.

The event competition elimination means 6 confirms whether a competitive attribute value is present by comparison of the attribute values (step S4).

When a competitive attribute value is present between the specified past event and the newly-input event (Yes in step S4), the event competition elimination means 6 does not employ an event having the competitive attribute value, and excludes it from the set of events associated with the entire rule specified in step S2 (step S6). At this time, the set of events remains in the original state.

The excluded event is held in the memory in the event processing device 10 until a certain period of time after the reception time.

When a competitive attribute value is not present between the specified past event and the newly-input event (No in step S4), the event evaluation means 3 includes the received event in the set of events associated with the entire rule specified in step S2 (step S5).

After including the received event in the set of events associated with the specified entire rule, the event evaluation means 3 confirms whether the set of events including the received event meets all the conditions to the end state described in the entire rule specified in step S2 (step S7).

When all the conditions to the end state are met (Yes in step S7), the event evaluation means 3 generates a complex event based on an analysis rule defined per rule in the entire rule specified in step S2. The result output means 5 outputs the generated complex event as an analysis result of the set of events (step S8).

When all the conditions to the end state are not met (No in step S7), the set of events keeps including the received event.

After comparing the attribute values between one received event and one past event, the event evaluation means 3 confirms whether a past event whose attribute values are not compared by the event competition elimination means 6 is present among the past events adapted to a rule in the entire rule specified in step S2 (step S9).

When a past event whose attribute values are not compared is present (Yes in step S9), the event competition elimination means 6 compares the attribute values between the received event and the past event again (step S3).

When a past event whose attribute values are not compared is not present (No in step S9), the event evaluation means 3 confirms whether the received event is included in any set of events (step S10).

When the received event is not included in any set of events (No in step S10), the event evaluation means 3 creates a new set of events based on the received event (step S11).

When the received event is included in any set of events (Yes in step S10) or after creating a new set of events (step S11), the event evaluation means 3 confirms whether an unevaluated event is present (step S12).

When an unevaluated event is present (Yes in step S12), the event reception means 1 receives a next event (step S1). When an unevaluated event is not present (No in step S12), the event processing device 10 terminates the processing.

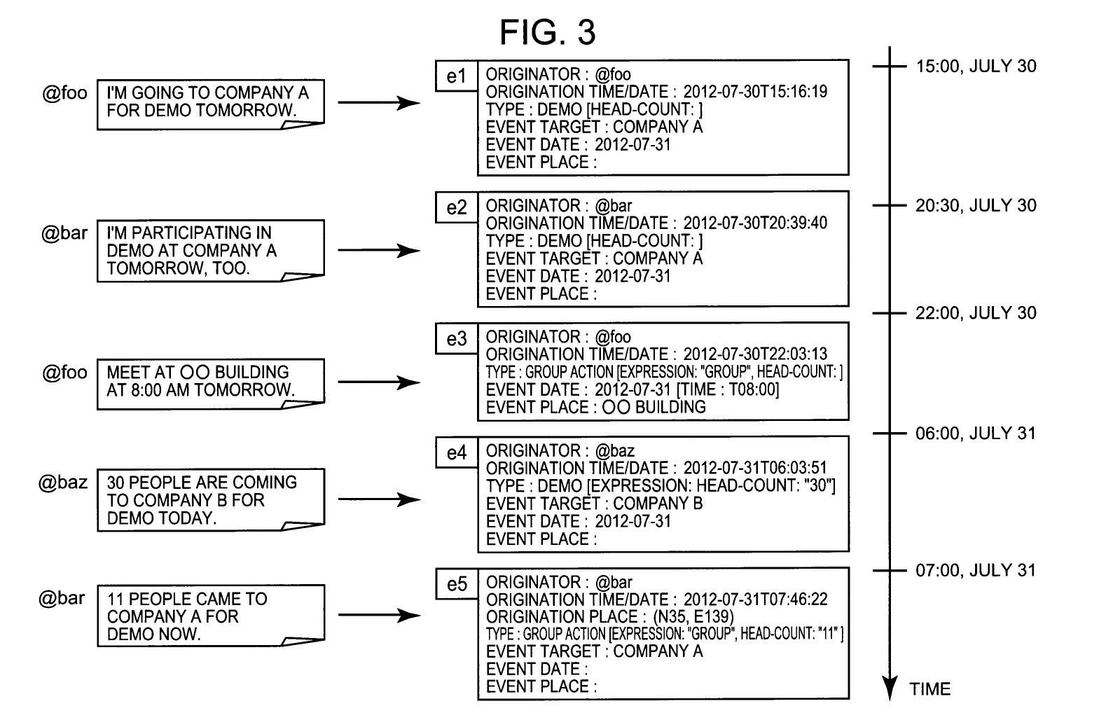

Exemplary specific events processed by the event processing device 10 according to the present invention will be described below with reference to FIG. 3.

FIG. 3 is an explanatory diagram illustrating original data indicating each event, and exemplary events e1 to e5 actually received by the event reception means 1. For example, it is assumed that the information originator identified by the name of “@foo” originates a message “I'm going to Company A for demonstration (denoted as demo below) tomorrow” on social media.

An event collection device (not illustrated) is used for generating an event from an originated message. The event collection device generates an event e1 with the originated message as original data. The event reception means 1 then receives the event e1.

Similarly, the event collection device converts one or more messages originated from the information originators identified by the names of “@bar” and “@baz” into events e2 to e5. After the messages are converted into the events, the event reception means 1 receives the converted events.

In the present example, the event collection device generates an event from a message, but the event reception means 1 may generate an event from a message, for example.

Each event includes the attributes such as originator, origination time/date, event type, event date and event place, and the respective attribute values thereof. In particular, event type is reference information for classifying an event.

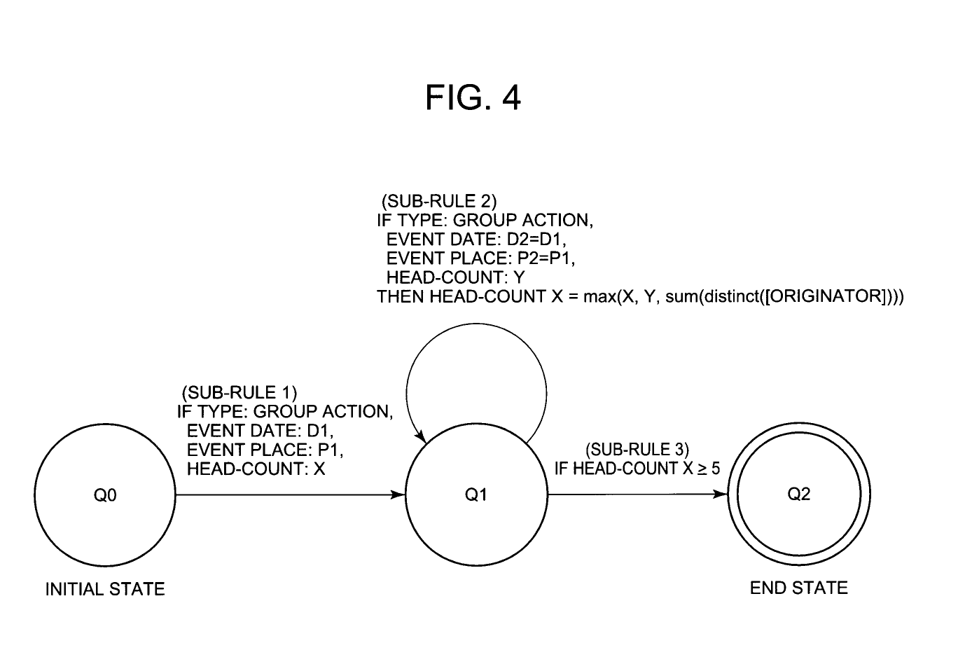

Subsequently, a specific example of the entire rule applied for evaluating an event will be described with reference to FIG. 4.

FIG. 4 is a state transition diagram illustrating exemplary rules for associating related events in the entire rule and exemplary conditions under which a set of specific events is established. The state transition diagram in FIG. 4 illustrates the respective states from generation of a set of specific events to the end.

With a sub-rule 1, a determination is made as to whether an event received by the event reception means 1 includes at least four attributes such as event type, event date, event place and head-count and an attribute value of event type is “group action.”

The attribute values of the attributes other than event type may each take any value depending on a range of each attribute, such as D1 for event date, P1 for event place and X for head-count, and may take no value.

When an event received by the event reception means 1 adapts to the sub-rule 1, the event evaluation means 3 transfers a state of the set of specific events from an initial state Q0 to a state Q1.

With a sub-rule 3, a determination is made as to whether the attribute value X for the set of specific events is 5 or more. When the set of specific events conforms to the sub-rule 3, the event evaluation means 3 immediately transfers the set of events in the state Q1 to an end state Q2.

When transferred to the end state Q2, the set of specific events meets an establishment condition defined by the rule specified by the event evaluation means 3. When the end state Q2 is reached, there is obtained data for which all the pairs of events required for the value X of head-count of 5 or more.

With a sub-rule 2, a determination is made as to whether an event received by the event reception means 1 includes four attributes such as event type, event date, event place and head-count, the values thereof are “group action”, D2, P2 and Y, respectively, D2 is equal to D1 and P2 is equal to P1.

When the event received by the event reception means 1 adapts to the sub-rule 2, the event evaluation means 3 records a value calculated by “max (X, Y, sum (distinct([originator])))” for the value X of head-count for the set of specific events transferred to the state Q1.

In the equation “max (X, Y, sum(distinct([originator])))” for calculating the value X of head-count in the sub-rule 2, “[originator]” indicates a value of the attribute “originator.” “distinct(X)” is a function for excluding overlapped X. “sum(X)” is a function for giving a total number of X. “max(X, Y, Z, • • • )” is a function for giving a maximum numerical value among X, Y, Z, • • 108

Assuming each function set in this way, the equation for calculating the value X of head-count returns the maximum value among the value X of the immediately-previous attribute “head-count” stored, the value Y of head-count for a newly-received event, a sum of the numbers of the attribute “originator” of all the events meeting the stored rule.

When comparing D1 with D2, and P1 with P2, if one of the attributes takes no value, the value of the attribute of the event having an attribute value is substituted into the value of the attribute of the event having no value. If both of the events have no value, the values of the attributes of both of the events are equal.

When the event reception means 1 further receives an event while the set of specific events is in the state Q1, the event evaluation means 3 reevaluates the attribute value X according to the sub-rule 3. When the attribute value X is 5 or more, the event evaluation means 3 transfers the state of the set of specific events to the end state Q2.

While the set of specific events is in the state Q1, all the events adapted to the sub-rule 1 are stored in the event storage means 4 until a predetermined deadline. When the event evaluation means 3 collates each condition of the specified rule with the past events, the events stored in the event storage means 4 are referred to.

The event evaluation means 3 compares and evaluates the attributes and the attribute values between the events, and updates the attributes and the attribute values based on required events and required processing in a current state among a series of events as illustrated in FIG. 3 and the entire rule illustrated in FIG. 4.

According to a rule in the entire rule illustrated in FIG. 4, when the event reception means 1 receives a plurality of events with the same type “group action”, the event evaluation means 3 compares the respective values of event date and event place according to the sub-rule 2 in the state Q1. When the values of event date for the received events are the same and the values of event place for the received events are also the same, the event competition elimination means 6 detects and eliminates a competition between the events.

Events e1 to e5 illustrated in FIG. 3 may each include the attributes such as originator, origination time/date, origination place and event target in addition to the attributes. In FIG. 3, the head-count attribute is described as a sub-attribute of the event type attribute. In an event e3, the event time attribute is described as a sub-attribute of the event date attribute. The sub-attributes indicate additional information to the attributes.

The steps in the flowchart illustrated in FIG. 2 will be described below in more detail by use of the events to be processed illustrated in FIG. 3 and a specific example of the entire rule applied during event evaluation illustrated in FIG. 4.

It is assumed that the rule storage means 2 stores only the entire rule including the sub-rule 1, the sub-rule 2 and the sub-rule 3 illustrated in FIG. 4. When the event reception means 1 receives the event e1 (step S1), the event evaluation means 3 confirms whether the entire rule including a rule adapted to the event e1 and adapted also to the past events is present among the entire rules stored in the rule storage means 2 (step S2).

When such an entire rule is not present (No in step S2), the event evaluation means 3 newly creates a set A of events in the initial state Q0 associated with the entire rule illustrated in FIG. 4 (step S11).

When the set A of events associated with the entire rule illustrated in FIG. 4 is in the initial state Q0, the event evaluation means 3 confirms whether received the event e1 includes the attributes such as event type, event date, event place and head-count according to the sub-rule 1. With reference to the event e1 illustrated in FIG. 3, the event e1 includes all the attributes required for meeting the conditions of the sub-rule 1.

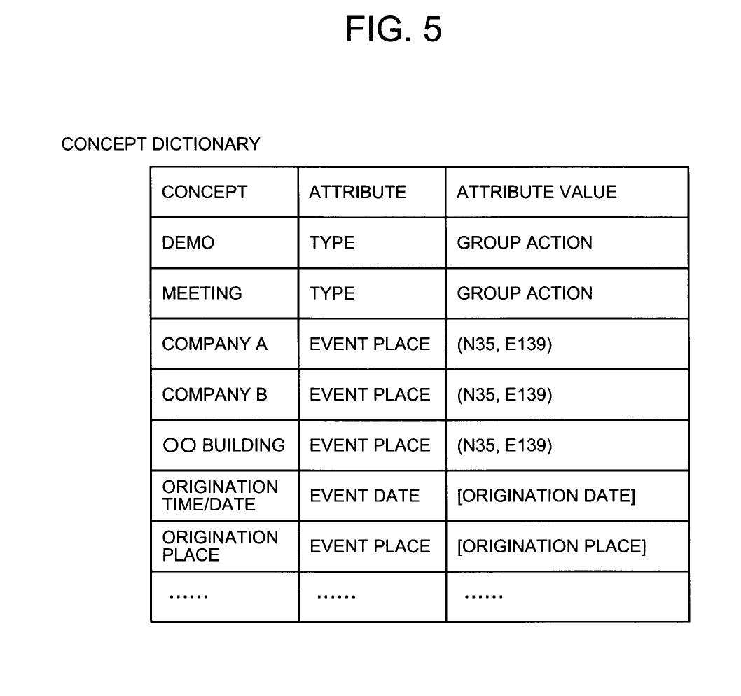

At this time, with reference to the concept dictionary illustrated in FIG. 5, for example, the event evaluation means 3 may directly compare attributes or attribute values not meeting the rule included in the events. The concept dictionary illustrated in FIG. 5 is a dictionary defining relationships between other attribute and attribute value derived from an attribute value of an attribute.

For example, the event e1 does not have an attribute value of “event place” but has an attribute value of “event target.” The attribute value of event target for the event e1 is “company A.” “Company A” is developed into the attribute “event place” and the attribute value “(N35, E139)” from the concept dictionary illustrated in FIG. 5.

Similarly, the value “demo” of type for the event e1 is developed into the attribute “type” and the attribute value “group action” from the concept dictionary illustrated in FIG. 5. Since the value of type is “group action” (or “demo”), the event e1 adapts to the sub-rule 1 illustrated in FIG. 4. Therefore, the event evaluation means 3 transfers the state of the set A of events including the event e1 to the state Q1.

After the processing for the event e1 end, a next event is present (Yes in step S12) and thus the event reception means 1 receives an event e2.

Subsequently, when the event reception means 1 receives the event e2 (step S1), the event evaluation means 3 confirms that the event e2 has the attributes such as type, event date, event place and head-count.

With reference to the concept dictionary illustrated in FIG. 5, the event evaluation means 3 confirms that the value of type for the event e2 is “group action” (or “demo”) similarly to the event e1. From the above, the event evaluation means 3 confirms that the event e2 adapts to the sub-rule 1.

When confirming that the event e2 adapts to the sub-rule 1, the event evaluation means 3 compares the attribute values between the event e1 stored in the event storage means 4 and a newly-received event e2 according to the sub-rule 2 illustrated in FIG. 4.

“Event date” for the event e1 has a value of “2012-07-31” and “event date” for the event e2 has the same date value, and thus the event evaluation means 3 determines that the event e1 and the event e2 have the same value of event date.

Similarly, the event evaluation means 3 compares the attribute “event place.” The attribute “event target” for the event e2 has an attribute value of “company A.” With reference to the concept dictionary illustrated in FIG. 5 similarly to the event e1, “company A” is developed into the attribute “event place” and the attribute value “(N35, E139).”

Therefore, event place for the event e1 has a value of the position “(N35, E139)” indicated by the latitude and longitude of the value “company A” of event target while event place for the event e2 has the same position value, and thus the event evaluation means 3 determines that the values of event place for the event e1 and the event e2 are equal to each other.

As described above, the event e2 meets all the conditions of the sub-rule 2 illustrated in FIG. 4 (Yes in step S2). Thus, the entire rule including a rule adapted to the event e2 and adapted also to the past events is present in the rule storage means 2.

For a typical CEP, an attribute value update (substitution) operation “head-count X=max(X, Y, sum(distinct([originator])))” is immediately performed on the sub-rule 2. To the contrary, the event processing device according to the first exemplary embodiment of the resent invention detects and eliminates a competition between events by the event competition elimination means 6 (step S3).

The event e1 and event e2 each have the attributes including event target, originator and origination time/date in addition to the already-evaluated type, event date, event place and head-count. Originator and origination time/date are meta-information on an originator. The event competition elimination means 6 does not detect and eliminate a competition for the meta-information. The excluded attributes may be previously defined.

Since the event e1 and event e2 have the same value of “event target” which is an unevaluated attribute, the event competition elimination means 6 determines that no competition is present between the event e1 and event e2 (No in step S4). After the determination, the event competition elimination means 6 returns the result to the event evaluation means 3.

The event evaluation means 3, which receives the processing result that “no competition is present” from the event competition elimination means 6, includes received the event e2 in the set A of events (step S5). Thereafter, the event evaluation means 3 updates the attribute value of the attribute “head-count” for the set A of events.

The event e1 and event e2 do not have a value of “head-count.” The originators of both of the events are “@foo” and “@bar”, respectively, and thus the value of “sum(distinct([originator]))” is “2.” Therefore, the value X of head-count for the set A of events in the state Q1 is the maximum value “2” (No in step S7).

At this stage, the set A of events does not meet a complex event output condition that the “value X of head-count is 5 or more” in the sub-rule 3. A set of events whose attribute values are not compared with those of the event e2 is not present. The event e2 is included in the set A of events, and thus the event reception means 1 receives a next event.

The event reception means 1 then receives the event e3 (step S1). The event evaluation means 3 confirms that the event e3 has the attributes including type, event date, event place and head-count. The event evaluation means 3 confirms that a value of type for the event e3 is “group action.” The event evaluation means 3 confirms that the event e3 adapts to the sub-rule 1.

After confirming that the event e3 adapts to the sub-rule 1, the event evaluation means 3 compares the attribute values between the event e1 stored in the event storage means 4 and a newly-received event e3 according to the sub-rule 2 illustrated in FIG. 4.

Event date for the event e1 has a value of “2012-07-31” while event date for the event e3 also has the same date value, and thus the event evaluation means 3 determines that the values of event date for the event e1 and the event e3 are equal to each other.

Similarly, the event evaluation means 3 compares the attribute “event place.” The event e3 has an attribute value of “oo building” of event target. With reference to the concept dictionary illustrated in FIG. 5, “00 building” is developed into the attribute “event place” and the attribute value “(N35, E139).”

Thus, event place for the event e1 has a value of the position “(N35, E139)” indicated by the latitude and longitude of the value “company A” of event target while event place for the event e3 also has the same position value, and thus the event evaluation means 3 determines that the values of event place for the event e1 and event e3 are equal to each other.

As described above, the event e3 meets all the conditions in the sub-rule 2 illustrated in FIG. 4 (Yes in step S2). Therefore, the entire rule including a rule adapted to the event e3 and adapted also to the past events is present in the rule storage means 2. Herein, the event competition elimination means 6 detects and eliminates a competition between the events (step S3).

The event e1 and event e3 each have the attributes including originator and origination time/date in addition to the already-evaluated type, event date, event place and head-count. Originator and origination time/date are meta-information on an originator, and thus the event competition elimination means 6 does not detect and eliminate a competition for the meta-information.

At this stage, therefore, the event competition elimination means 6 has no attribute for which a competition is to be detected. Based on the above result, the event competition elimination means 6 determines that no competition is present between the event e1 and event e3 (No in step S4). After the determination, the event competition elimination means 6 returns the result to the event evaluation means 3.

The event evaluation means 3, which receives the processing result that “no competition is present” from the event competition elimination means 6, includes received the event e3 in the set A of events (step S5). Thereafter, the event evaluation means 3 performs an attribute value update operation on the attribute “head-count” for the set A of events.

The event e1 stored in the event storage means 4 and the newly-received event e3 are originated from the same originator, and thus the value of “sum(distinct([originator]))” remains at “2.” The attribute “head-count” for the event e3 has no value. Thus, the value X of head-count also remains at “2” (No in step S7).

At this stage, the set A of events does not meet a complex event output condition that the “value X of head-count is 5 or more” in the sub-rule 3. A set of events whose attribute values are not compared with those of the event e3 is not present. The event e3 is included in the set A of events, and thus the event reception means 1 receives a next event.

The event reception means 1 then receives an event e4 (step S1). The event evaluation means 3 confirms that the event e4 has the attributes including type, event date, event place and head-count. The event evaluation means 3 confirms that a value of type for the event e4 is “group action” (or “demo”) similarly to the event e1 from the concept dictionary.

After confirming that the event e4 adapts to the sub-rule 1, the event evaluation means 3 compares the attribute values between the event e1 stored in the event storage means 4 and newly-received the event e4 according to the sub-rule 2 illustrated in FIG. 4.

Event date for the event e1 has a value of “2012-07-31” while event date for the event e4 has the same date value, and thus the event evaluation means 3 determines that the values of event date for the event e1 and event e4 are equal to each other.

Similarly, a comparison is made for the attribute “event place.” The event e4 has an attribute value of “company B” of event target. With reference to the concept dictionary illustrated in FIG. 5, “company B” is developed into the attribute “event place” and the attribute value “(N35, E139).”

Thus, event place for the event e1 has a value of the position “(N35, E139)” indicated by the latitude and longitude of the value “company A” of event target while event place for the event e4 has the same position value, and thus the event evaluation means 3 determines that the values of event place for the event e1 and event e4 are equal to each other.

As described above, the event e4 meets all the conditions in the sub-rule 2 illustrated in FIG. 4 (Yes in step S2). Thus, the entire rule including a rule adapted to the event e4 and adapted also to the past events is present in the rule storage means 2. Herein, the event competition elimination means 6 detects and eliminates a competition between the events (step S3).

The event e1 and event e4 each have the attributes including event target, originator and origination time/date in addition to the already-evaluated type, event date, event place and head-count. Originator and origination time/date are meta-information on an originator, and thus the event competition elimination means 6 does not detect and eliminate a competition for the meta-information.

Among the attributes having the attribute values, for the attribute “event target” for which a competition is not detected, the event e1 and event e2 have a value of “company A”, but a newly-received event e4 has a value of “company B”, which are different from each other.

Since the values of the attribute “event target” are different from each other (Yes in step S4), the event competition elimination means 6 determines that the event e4 cannot be associated with the past events in the set A of events in the state Q1.

As a result of the determination, the event competition elimination means 6 excludes newly-received the event e4 from the set A of events including the event e1 in the state Q1 (step S6). Thereby, the event evaluation means 3 does not perform an attribute value update operation on the attribute “head-count” for the set A of events.

A set of events, which are not collated with the event e4 for their attributes, is not present. The event e4 is not included in any set of events.

Excluded the event e4 adapts to the sub-rule 1 illustrated in FIG. 4. Therefore, the event evaluation means 3, which receives the result that a “competition is present” from the event competition elimination means 6, assumes the event e4 as an initially-received event, and generates a new set B of events in the state Q1 associated with the entire rule illustrated in FIG. 4 (step S11).

After a new set of events is created, the event reception means 1 receives a next event.

Next, when the event reception means 1 receives an event e5 (step S1), the event evaluation means 3 confirms that the event e5 have the attributes including type, event date, event place and head-count.

With reference to the concept dictionary illustrated in FIG. 5, the event evaluation means 3 confirms that a value of type for the event e5 is “group action” similarly to the event e1. As described above, the event evaluation means 3 confirms that the event e5 adapts to the sub-rule 1.

After confirming that the event e5 adapts to the sub-rule 1, the event evaluation means 3 compares the attribute values between the event e1 stored in the event storage means 4 and a newly-received event e5 according to the sub-rule 2 illustrated in FIG. 4.

The event e5 has an attribute value of “(N35, E139)” of origination place, an attribute value of “2012-07-31 T07:46:22” of origination time/date, and an attribute value of “company A” of event target. With reference to the concept dictionary illustrated in FIG. 5 similarly to the event e1, “(N35, E139)” and “company A” are developed into the attribute “event place” and the attribute value “(N35, E139).” Further, “2012-07-31 T07:46:22” is developed into the attribute “event date” and the attribute value “2012-07-31.”

Event date for the event e1 has a value of “2012-07-31” while event date for the event e5 also has the same date value, and thus the event evaluation means 3 determines that the values of event date for the event e1 and event e5 are equal to each other.

Event place for the event e1 has a value of the position “(N35, E139)” indicated by the latitude and longitude of the value “company A” of event target while event place for the event e5 also has the same position value, and thus the event evaluation means 3 determines that the values of event place for the event e1 and event e5 are equal to each other.

As described above, the event e5 meets all the conditions in the sub-rule 2 illustrated in FIG. 4 (Yes in step S2). Thus, the entire rule including a rule adapted to the event e5 and adapted also to the past events is present.

The two sets such as set A of events and the set B of events are detected for a competition with the event e5 by the event competition elimination means 6 at this stage. Thus, the event competition elimination means 6 first detects and eliminates a competition with the set A of events including the event e1 (step S3).

The event e1 and event e5 each have the attributes including event target, originator and origination time/date in addition to the already-evaluated type, event date, event place and head-count. Originator and origination time/date as well as origination place owned by only the event e5 are meta-information on an originator, and thus the event competition elimination means 6 does not detect and eliminate a competition for the meta-information.

The event e1 and event e5 have the same value of event target which is an unevaluated attribute, and thus the event competition elimination means 6 determines that no competition is present between the event e1 and event e5 (No in step S4). After the determination, the event competition elimination means 6 returns the result to the event evaluation means 3.

The event evaluation means 3, which receives the processing result that “no competition is present” determined by the event competition elimination means 6, includes received the event e5 in the set A of events (step S5). Thereafter, the event evaluation means 3 updates an attribute value of the attribute “head-count” for the set A of events.

A value of the attribute “head-count” for the event e5 is 11. The maximum value is 11 among a value of 0 of the immediately-previous attribute “head-count” for the set A of events stored in the event storage means 4, a value of 11 of head-count for the newly-received event e5, and a sum of 2 of the numbers of the attribute “originator” for all events adapted to the rule stored in the event storage means 4. Therefore, the value X of head-count changes “2” to “11” due to the event e5.

At this stage, the set A of events in the state Q1 meets a complex event output condition that the “value X of head-count is 5 or more” in the sub-rule 3 (Yes in step S7). Thereby, the event evaluation means 3 transfers the state of the set A of events to the end state Q2.

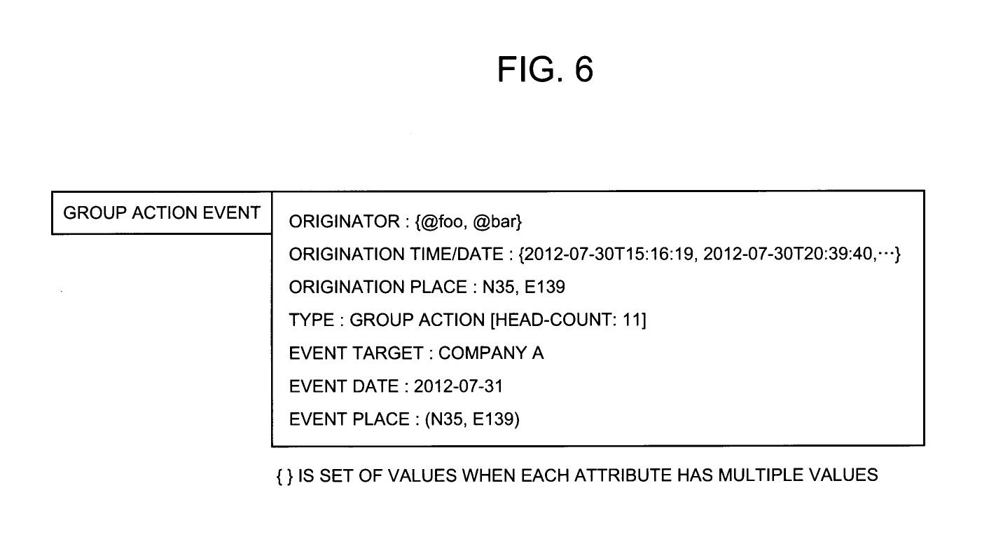

After transferring to the end state Q2, the event evaluation means 3 terminates applying a series of rules to the set A of events. Consequently, a complex event as illustrated in FIG. 6 is output by the result output means 5 (step S8). FIG. 6 is an explanatory diagram illustrating an exemplary complex event output from the event processing device.

The set B of events is present as a set of events whose attribute values are not compared with those for the event e5 (Yes in step S9). Thus, the event competition elimination means 6 detects and eliminates a competition between the events again (step S3).

The event e4 and event e5 each have the attributes including event target, originator and origination time/date in addition to the already-evaluated type, event date, event place and head-count. Originator and origination time/date are meta-information on an originator, and thus the event competition elimination means 6 does not detect and eliminate a competition for the meta-information.

For event target which is an unevaluated attributed, the event e4 has a value of “company B” and newly-received the event e5 has a value of “company A”, which are different from each other.

Since the values of the attribute “event target” are different from each other (Yes in step S4), the event competition elimination means 6 determines that the event e5 cannot be associated with the past events in the set B of events in the state Q1.

As a result of the determination, the event competition elimination means 6 excludes the newly-received event e5 from the set B of events including the event e4 in the state Q1 (step S6). Thereby, the event evaluation means 3 does not perform an attribute value update operation on the attribute “head-count” for the set B of events.

At this stage, a set of events whose attribute values are not compared with those for the event e5 is not present. The event e5 is included in the set A of events. An unevaluated event is not present, and thus the event processing device 10 terminates the processing.

The output complex events may be integrated as one complex event as illustrated in FIG. 6, or may be a set of all the events required for meeting the complex event establishment conditions in the entire rule.

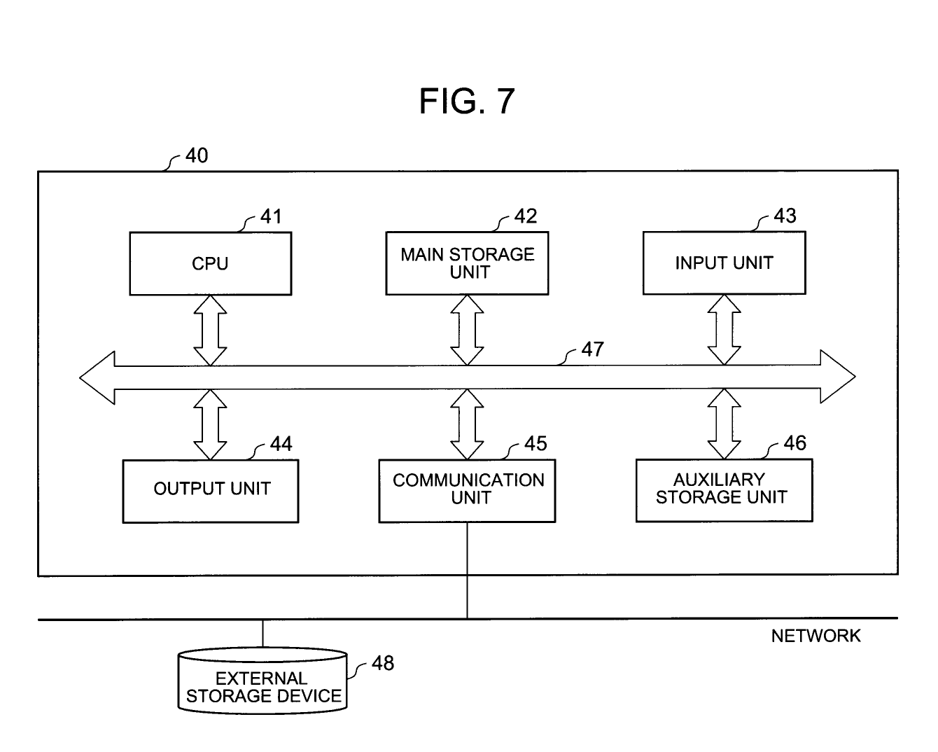

A specific example of a hardware structure of the event processing device according to the first exemplary embodiment of the present invention will be described below. FIG. 7 is an explanatory diagram illustrating an exemplary hardware structure of the event processing device according to the present invention.

An event processing device 40 illustrated in FIG. 7 includes at least a CPU (Central Processing Unit) 41, a main storage unit 42, a communication unit 45, and an auxiliary storage unit 46. It may further include a human-operated input unit 43, and an output unit 44 for presenting a processing result or a progress of processing contents to a person.

The main storage unit 42 is used as a working area for data or a temporary save area for data. The main storage unit 42 is a main memory such as RAM (Random Access Memory).

The input unit 43 has a function of inputting data or processing instructions. The input unit 43 is an input device such as keyboard or mouse.

The output unit 44 has a function of outputting data. The output unit 44 is a display device such as liquid crystal display device, or a print device such as printer.

The communication unit 45 has a function of inputting/outputting data into/from a peripheral device via a wired or wireless network (information communication network).

The auxiliary storage unit 46 is a hard disk device or other storage device.

As illustrated in FIG. 7, the components in the event processing device 40 are mutually connected via a system bus 47.

The auxiliary storage unit 46 stores therein the programs for realizing the event reception means 1, the event evaluation means 3, the result output means 5, and the event competition elimination means 6 illustrated in FIG. 1.

The auxiliary storage unit 46 is further used as a storage area for the rule storage means 2 or the event storage means 4. The rule storage means 2 or the event storage means 4 may use only the main storage unit 42 without using the auxiliary storage unit 46.

The event reception means 1 acquires data handled as an event via the input unit 43 or the communication unit 45.

The event processing device 40 may be realized in hardware by being mounted with a circuit configured of a hardware component such as LSI (Large Scale Integration) incorporating therein the programs for realizing the functions as illustrated in FIG. 1.

As illustrated in FIG. 7, the CPU 41 in the computer executes the programs providing the functions as illustrated in FIG. 1 so that the event processing device 40 may be realized in software.

In this case, the CPU 41 loads and executes the programs stored in the auxiliary storage unit 46 into the main storage unit 42 thereby to control the operations of the event processing device 40 so that each function is realized in software.

The communication unit 45 is connected to a peripheral device and has a function of exchanging data therewith. An external storage device 48 as a peripheral device is connected to the event processing device 40 via a network.

The event reception means 1 may acquire an event stored in the external storage device 48 by inputting it in the communication unit 45 via a network. Further, data including a complex event output by the result output means 5 may be stored in the external storage device 48.

When the event processing device according to the present exemplary embodiment is used, the user can sequentially process and eliminate competitions in contents between individually-input events.

### Second Exemplary Embodiment

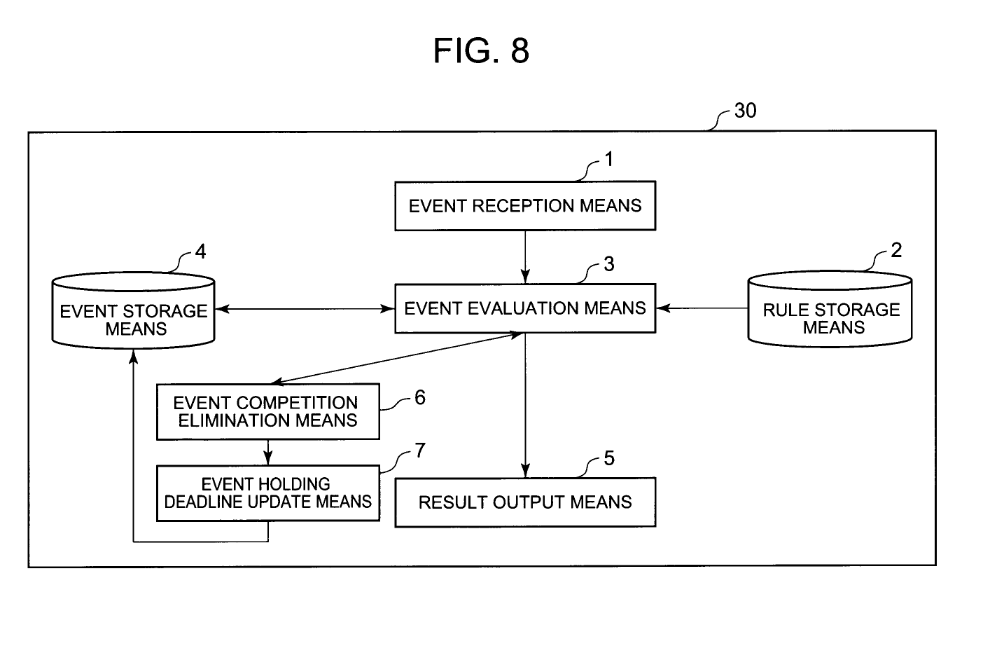

A second exemplary embodiment according to the present invention will be described below. FIG. 8 is a block diagram illustrating a structure of an event processing device 30 according to the second exemplary embodiment of the present invention. The event processing device 30 is different from the event processing device 10 according to the first exemplary embodiment of the present invention in that an event holding deadline update means 7 is added, and is common with the event processing device 10 in other components.

The event holding deadline update means 7 updates a holding deadline for holding the past events in the event storage means 4, which are associated by the entire rule including a rule adapted to a received latest event, in accordance with a holding deadline of the latest event. Further, the event holding deadline update means 7 may delete an event after its holding deadline.

For example, an initial holding deadline of a received event is assumed at the later time/date out of a time/date six hours later than the reception time/date and an event generated time/date described in the received event. In the example of the events illustrated in FIG. 3, the holding deadline of the event e1 is six hours later than its reception, a time of 21:16:19, Jul. 30, 2012.

Thereafter, the event e2 is received and the event e2 adapts to the same rule as the event e1, and thus the event evaluation means 3 determines that the event e2 is associated with the event e1. At this time, the holding deadline of the event e1 is updated to a time of 02:39:40, Jul. 31, 2012, which is the same holding deadline as the event e2, by the event holding deadline update means 7.

When the event e3 is received, the holding deadlines of the event e1 and event e2 are similarly updated to a time of 08:00:00, Jul. 31, 2012, which is the same as the event generated time/date described in the event e3, by the event holding deadline update means 7.

The event processing device 30 according to the second exemplary embodiment of the present invention is realized in the hardware structure illustrated in FIG. 7 similarly to the event processing device 10 according to the first exemplary embodiment.

The event holding deadline update means 7 as a component in the event processing device 30, which is not provided in the event processing device 10, is stored as a program in the auxiliary storage unit 46 illustrated in FIG. 7 similarly to other means. The CPU 41 executes the program stored in the auxiliary storage unit 46 so that the event holding deadline update means 7 is realized in software.

Alternatively, the event holding deadline update means 7 is realized also in hardware by being mounted as a circuit configured of a hardware component such as LSI.

As described above, by use of the event processing device 30 further including the event holding deadline update means 7, the event holding deadlines are continuously updated while the associated events are continuously received. Thus, old events are not deleted due to expiration. Thereby, the event processing device 30 can use information on the past associated events.

Even an event adapted to the rules in the entire rule is deleted due to expiration if its holding deadline is not updated depending on a subsequent associated event reception situation. Therefore, also when an associated event leading to the end state of the entire rule is not received for a long period of time, the storage capacity of the event storage means 4 is not needlessly stressed.

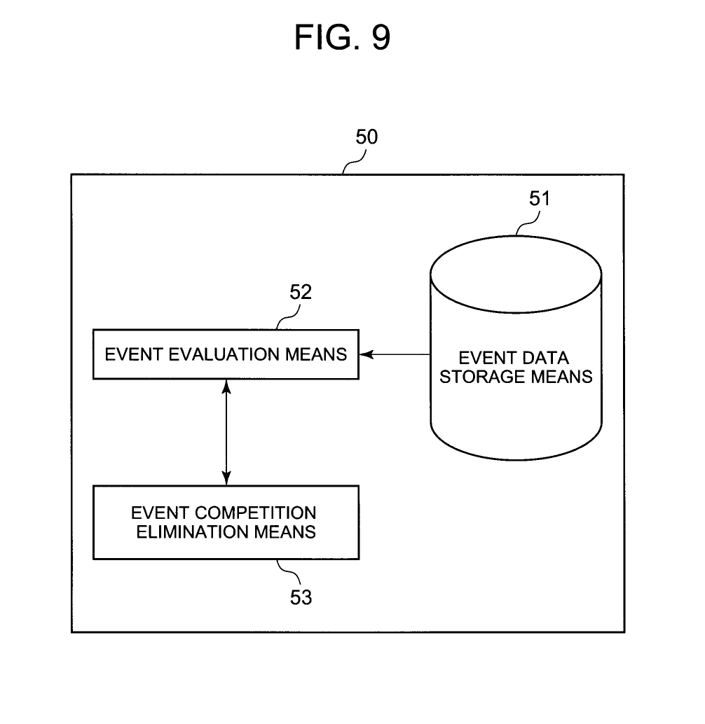

An outline of the present invention will be described below. FIG. 9 is a block diagram illustrating an outline of the event processing device according to the present invention. An event processing device 50 according to the present invention includes an event data storage means 51 (the event storage means 4, for example), an event evaluation means 52 (the event evaluation means 3, for example), and an event competition elimination means 53 (the event competition elimination means 6, for example).

The event data storage means 51 stores a set of event data mutually associated under a predetermined condition (such as the sub-rule 1) until a predetermined holding deadline.

When newly-input event data meets a predetermined condition, the event evaluation means 52 includes the event data as new event data in the set.

When the new event data is competitive data that a competition is generated with an attribute value (such as an attribute value other than event date and event place in the sub-rule 1) of an attribute common with other event data included in the set, the event competition elimination means 53 excludes the competitive data from the set.

With the structure, competitions in contents between individually-input events are sequentially processed and eliminated by the event processing device 50.

The event processing device 50 may further include an event holding deadline update means for updating a holding deadline of event data associated under the predetermined condition in accordance with a holding deadline of newly-input event data.

When determining whether event data mutually associated under a predetermined condition are competitive due to different values of a common attribute, the event competition elimination means 53 may not determine whether they are competitive for a specific attribute.

The event processing device 50 includes a result output means for outputting a complex event as an analysis result which is an analyzed set of event data, the event evaluation means 52 may determine whether to generate a complex event under a predetermined condition, and may generate the complex event, and the result output means may output the generated complex event.

The event processing device 50 includes a rule storage means for storing a concept dictionary defining a relationship between other attribute and attribute value derived from one attribute or attribute value, the event evaluation means 52 develops other attribute and attribute value from the concept dictionary based on an attribute or attribute value included in new event data, and the event competition elimination means 53 may determine whether the new event data is competitive data by use of the developed attribute and attribute value.

The present application claims the priority based on Japanese Patent Application No. 2012-229796 filed on Oct. 17, 2012, the entirety of which is all incorporated herein by reference.

The present invention has been described above with reference to the exemplary embodiments, but the present invention is not limited to the exemplary embodiments. The structure or details of the present invention may be variously modified within the scope of the present invention understandable by those skilled in the art.

### INDUSTRIAL APPLICABILITY

The present invention is suitably applied to a complex event processing device into which data indicating a plurality of events, which may include mutually overlapped or contradictory contents, is input.

### REFERENCE SIGNS LIST

1 Event reception means
2 Rule storage means
3 Event evaluation means
4 vent storage means
5 Result output means
6 Event competition elimination means
7 Event holding deadline update means
10 Event processing device
20 Complex event processing device (CEP processing device)
30 Event processing device
40 Event processing device
41 CPU
42 Main storage unit
43 Input unit
44 Output unit
45 Communication unit
46 Auxiliary storage unit
47 System bus
48 External storage device
50 Event processing device
51 Event data storage means
52 Event evaluation means
53 Event competition elimination means

What is claimed is:

1. An event processing device comprising:
an event data storage unit for storing a set of event data mutually associated under a predetermined condition until a predetermined holding deadline;
an event evaluation unit for, when newly-input event data meets the predetermined condition, including the event data as new event data in the set; and
an event competition elimination unit for, when the new event data is competitive data in which a competition is caused in attribute values of a common attribute with other event data included in the set, excluding the competitive data from the set.

2. The event processing device according to claim 1, comprising:
an event holding deadline update unit for updating a holding deadline of event data associated under the predetermined condition in accordance with a holding deadline of newly-input event data.

3. The event processing device according to claim 1,
wherein when determining whether event data mutually associated under a predetermined condition are competitive data having different values of a common attribute, the event competition elimination unit does not determine whether the event data are competitive data by comparing values of a specific attribute.

4. The event processing device according to claim 1, comprising:
a result output unit for outputting a complex event as an analysis result which is an analyzed set of event data,
wherein the event evaluation unit determines whether to generate the complex event under a predetermined condition, and generates the complex event when determined to generate the complex event, and
the result output unit outputs the generated complex event.

5. The event processing device according to claim 1, comprising:
a rule storage unit for storing a concept dictionary defining a relationship between other attribute and its attribute value derived from one attribute or attribute value,
wherein the event evaluation unit develops other attribute and its attribute value from the concept dictionary based on an attribute or attribute value included in new event data, and
the event competition elimination unit determines whether new event data is competitive data by use of the developed attribute and attribute value.

6. An event processing method comprising the steps of:
storing a set of event data mutually associated under a predetermined condition until a predetermined holding deadline;
when newly-input event data meets the predetermined condition, including the event data as new event data in the set; and
when the new event data is competitive data in which a competition is caused in attribute values of a common attribute with other event data included in the set, excluding the competitive data from the set.

7. The event processing method according to claim 6, comprising the step of:
updating a holding deadline of event data associated under the predetermined condition in accordance with a holding deadline of newly-input event data.

8. A non-transitory computer-readable recording medium in which an event processing program is recorded, the event processing program causing a computer to perform:
event data storage processing of storing a set of event data mutually associated under a predetermined condition until a predetermined holding deadline;
event evaluation processing of, when newly-input event data meets the predetermined condition, including the event data as new event data in the set; and
event competition elimination processing of, when the new event data is competitive data in which a competition is caused in attribute values of a common attribute with other event data included in the set, excluding the competitive data from the set.

9. The non-transitory computer-readable recording medium in which the event processing program is recorded according to claim 8, the program causing a computer to perform:
event holding deadline update processing of updating a holding deadline of event data associated under the predetermined condition in accordance with a holding deadline of newly-input event data.
